(19) United States
(12) Patent Application Publication
(10) Pub. No.: US 2009/0091295 A1
(43) Pub. Date: Apr. 9, 2009

(54) BALANCED CHARGING/DISCHARGING CIRCUIT FOR LITHIUM BATTERY SET

(76) Inventor: Wei-Liang Wan, Longtan Township (TW)

Correspondence Address: LEONG C LEI, PMB # 1008, 1867 YGNACIO VALLEY ROAD, WALNUT CREEK, CA, 94598, US

(21) Appl. No.: 11/549,656

(22) Filed: Oct. 16, 2006

(51) Int. Cl. H02J 7/00

(52) U.S. Cl. 320/134

(57) ABSTRACT

A balanced charging/discharging circuit for a lithium battery set, including a plurality of serially connected lithium batteries each having a positive electrode controlled by a corresponding control signal to selectively establish connection with a positive electrode of a battery charging circuit, and a negative electrode controlled by a corresponding control signal to selectively establish connection with a negative electrode of the battery charging circuit. Voltage of the positive and negative electrodes of each of the serially connected lithium batteries is transmitted to a corresponding terminal of a control circuit respectively so that the control circuit generates a corresponding transfer signal to the battery charging circuit and supplies the control signal to establish connection of a corresponding series of lithium batteries for charging. Battery sets arranged in series or in parallel can be charged with the maximum current and the service life is extended and charging time is shortened.

### BACKGROUND OF THE INVENTION

(a) Technical Field of the Invention

The present invention relates generally to a balanced charging/discharging circuit, and in particular to an improved charging/discharging circuit that, during a changing process, carries out constant detection and application of the voltage of each individual lithium battery of a battery set to a control circuit, which, in response thereto, generates a transfer signal to a battery charging circuit to provide a proper charging current, to charge each individual lithium battery to a proper voltage level.

(b) Description of the Prior Art

Lithium ion batteries, lithium polymer batteries, and other lithium based chemical cells have generally different discharging characteristics from other types of secondary cells. The lithium based batteries or cells are easily subject to damage when they are over-discharged or being of over-temperature. Further, over-temperature may also cause explosion of the lithium based batteries, especially when a number of lithium batteries are connected in series and/or in parallel to effect high current charging and discharging for power tools that requires much larger output power than a single cell can provide. In such applications, the lithium batteries are much more easily subject to damages caused by over-discharging and the costs are much higher when the batteries are so damaged. Also, explosion of the batteries is more powerful, if it happens. Apparently, a protection circuit is often employed to detect voltage and temperature of the lithium battery during a discharging process thereof and to immediately cut off the discharging current at the time when abnormal events occur. Further, the voltage specification of a fully charged battery is subject to only a very minor tolerance. For example, the voltage of an individual fully charged battery is 4.15V±0.05V. Over-charging often results in damages and may induce a great amount of heat which in turn leads to risk of explosion. On the other hand, insufficient charging, even a difference of 0.10V results in an reduction of 7%-10% of the battery capacity so that when a number of batteries are connected in series, monitoring the situation of the batteries by detecting the overall voltage cannot ensure that each individual battery is not subject to over-charging or over-discharging. This is particularly true when the characteristics of each battery within a battery set becomes substantially different from each other after a long term operation, which makes the voltage of each battery different and unbalanced. This is one of the major causes for deterioration of the battery.

Device that detects each individual battery and cuts off charging current when the battery is charged to an upper limit or cuts off discharging current when the battery is discharged to a lower limit to effect protection of the battery is available in the market. However, the service life of the battery still goes down after each cycle of charging. Thus, to extend the service life of the battery and short the charging time, when battery sets that are connected in series or in parallel are charged with a large current, the charging process of each individual battery must be controlled and charged to the optimum condition and each individual battery must be controlled not to exceed the lower limit in a discharging process. This cannot be realized with the conventional charging methods.

In view of the above drawbacks, the present invention is aimed to provide a balanced charging/discharging circuit for lithium battery that overcomes the conventional drawbacks.

### SUMMARY OF THE INVENTION

The primary purpose of the present invention is to provide a balanced charging/discharging circuit for lithium battery, which overcomes the above discussed drawbacks and provides a multiple stage charging method so that during a charging process, each individual battery is subject to detection of the voltage thereof and is put in connection with a battery charging circuit to realize balanced charging and have each individual battery charged to a proper voltage level with proper current and in a divided charging manner.

Another objective of the present invention is to provide a balanced charging/discharging circuit for lithium battery which comprises a protection mechanism against abnormal voltage/abnormal temperature/abnormal current so as to substantially reduce the risk of explosion or damage and to minimize the leakage current and to maintain the power in a long term on-shelf period. An intelligent battery pack can be formed with the circuit for portable power devices that consumes large power and the battery pack can be made with substantially the same size and configuration as the conventional nickel/cadmium battery or nickel-metal-hydride battery for easy replacement of the conventional batteries.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a block diagram of a balanced charging/discharging circuit for a lithium battery set in accordance with a preferred embodiment of the present invention;

FIG. 2 shows a block diagram of a balanced charging/discharging circuit for a lithium battery set in accordance with another preferred embodiment of the present invention;

FIG. 3 shows a modified example of the circuit architecture of FIG. 2;

FIG. 4 shows a block diagram of a balanced charging/discharging circuit fox a lithium battery set in accordance with a further preferred embodiment of the present invention;

FIG. 5 shows a block diagram of a balanced charging/discharging circuit for a lithium battery set in accordance with yet a further preferred embodiment of the present invention.

### DETAILED DESCRIPTION OF THE PREFERRED EMBODIMENTS

The following descriptions are of exemplary embodiment only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

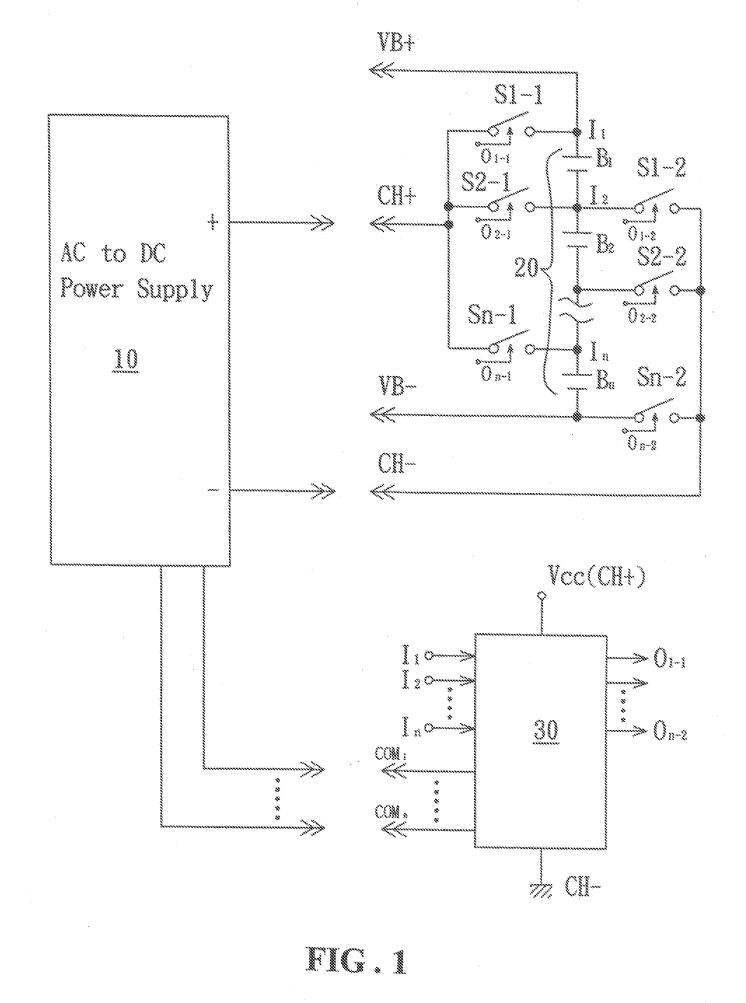

With reference to the drawings and in particular to FIG. 1, a block diagram of a balanced charging/discharging circuit for a lithium battery set is shown, in which CH+ and CH− respectively denote positive and negative electrodes of a battery charging circuit 10 and VB+ and VB− respectively denote positive and negative electrodes of a discharging circuit of a battery pack 20. The battery charging circuit 10 comprises a power source, which can be switching power supply or a conventional transformer. As show in the drawings, in the balanced charging/discharging circuit of lithium battery pack, the battery pack 20 comprises a plurality of serially connected lithium batteries B1, B2, Bn each having a positive electrode controlled by a corresponding control signal O1−1, O2−1, On−1 to selectively establish connection with the positive electrode CH+ of the battery charging circuit 10 and a negative electrode controlled by a corresponding control signal O1−2, O2−2, On−2 to selectively establish connection with the negative electrode CH− of the battery charging circuit 10 (wherein as shown in the drawings, the arrangement that employs the control signals O1−1, O2−1, On−1 to respectively establish connection with the positive electrode CH+ of the battery charging circuit 10 can be realized by signal-steering switches S1−1, S2−1, Sn−1 and the arrangement that employs the control signals O1−2, O2−2, On−2 to respectively establish connection with the negative electrode CH− of the battery charging circuit 10 can be realized by means of signal-steering switches S1−2, S2−2, Sn−2), and voltage (I1, I2, In) of the positive/negative electrode of each of the serially connected batteries B1, B2, Bn is applied to a corresponding terminal of a control circuit 30 respectively to make the control circuit 30 generate, in response thereto, transfer signals COM1, COMn to the battery charging circuit 10 and outputs the control signals O1−2, O2−2, On−2 to establish connection of the respective ones of the serially connected lithium batteries B1, B2, Bn for carrying out charging operation thereof, and at the same time, the control circuit 30 drives one of the control signals (O1−1 or O2−1 or On−1) to establish connection with the positive electrode of the battery charging circuit 10, and also drive one of the control signals (O2−1 or O2−2 or On−2) to establish connection with the negative electrode of the battery charging circuit 10, with no connection established by other positive/negative electrode control signals, for carrying out charging operation on a series of successive lithium batteries Bn, Bn+1, Bn+2 or that single one of lithium battery (B1 or B2 or Bn).

For example, when the signal-steering switch. S1−1 of the positive electrode of the first lithium battery B1 and the signal-steering switch S2−2 of the negative electrode of the last lithium battery Bn are conducted on, the whole series of the lithium batteries B1, B2, Bn are all charged. Thus, by conducting one an pair of the signal-steering switches (such, as S1−1 and S1−2; S1−1 and S2−2; S1−1 and Sn−2; S2−1 and S2−2, S2−1 and Sn−2; Sn−1 and Sn−2), together with a proper charging current, charging can be performed on several successive and serially connected lithium batteries Bn, Bn+1, Bn+2, or a single one of the lithium batteries (B1 or B2 or Bn), In the control circuit 30, a single-chip microprocessor is provided, serving to detect the voltage I1, I2, In of each lithium during a charging process and execute built in program to determine to charge which series of serially connected lithium batteries Bn, Bn+1, Bn+2, or to charge winch single lithium battery (B1 or B2 or Bn), and one or more terminals for supplies corresponding transfer signals COM1, COMn to the battery charging circuit 10 to determine charging current mode. Thus, during each charging process, each lithium battery (B1 or B2 or Bn) can be charged to a voltage that most satisfy desired requirements. In addition, power source Vcc (CH+) of the control circuit 30 can be supplied by the positive electrode, denoted C+, of the battery charging circuit 10. Thus, in a non-charging condition, where CH+ is not supplied with power, the control circuit 30 is not supplied with power and all signal-steering switches (S1−1, S2−1, Sn−1, S1−2, S2−2, and Sn−2) and the discharging circuit are all conducted off or opened and consequently, leakage current is extremely small. Further, in the control circuit 30 that is arranged close to fee lithium batteries B1, B2, Bn, one or more thermal resistors (not shown) is provided to serve as a protection element. The variation of the resistance of the thermal resistor indicates the variation of the temperature of the lithium batteries B1, B2, Bn, based on which protection against abnormal temperature can be initiated.

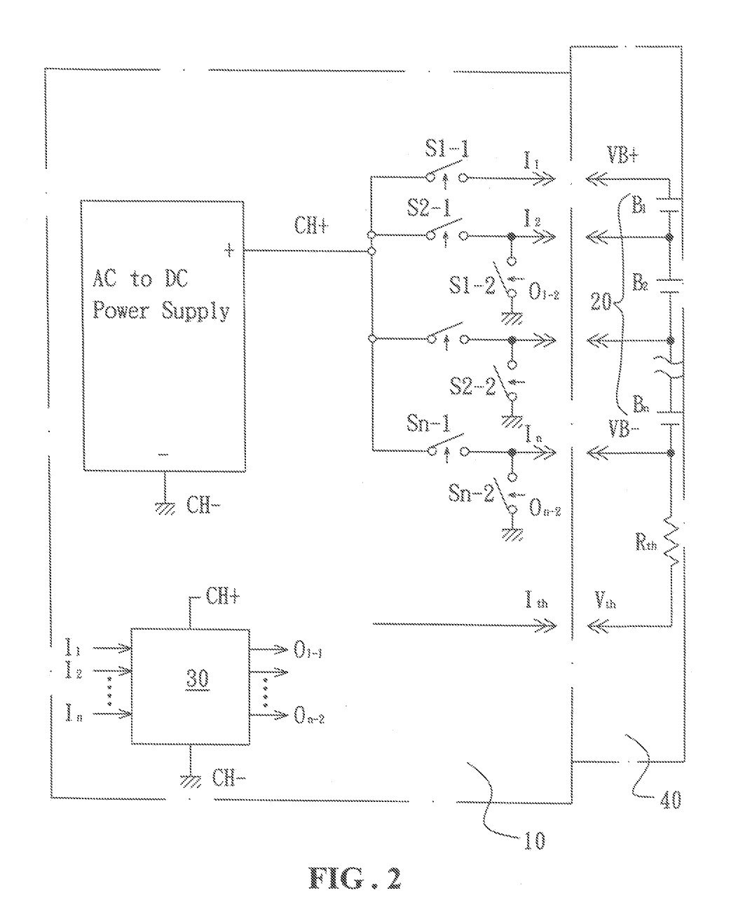

A different example of the present invention is shown in FIG. 2, wherein a plurality of lithium batteries B1, B2, Bn are connected in series to form a battery set 20, to which one or more thermal resistors Rth are serially connected, and both are packaged together in a battery pack 40. The signal-steering switches (S1−1, S2−1, Sn−1, S2−1, S2−2, Sn−2) and the control circuit 30 are both included in the battery charging circuit 10 with the positive/negative electrodes of each lithium battery B1, B2, Bn and an un-connected end of the thermal resistor Rth exposed outside the battery pack 40 to form mating terminals, to which counterpart terminals formed in the battery charging circuit 10 correspond, so that to carry out charging operation, the mating terminals and the counterpart terminals are positioned to engage each other and completing a charging mechanism. In this way, heat generation components are positioned in the battery charging circuit 10 and thus the costs of the battery set 20 are reduced.

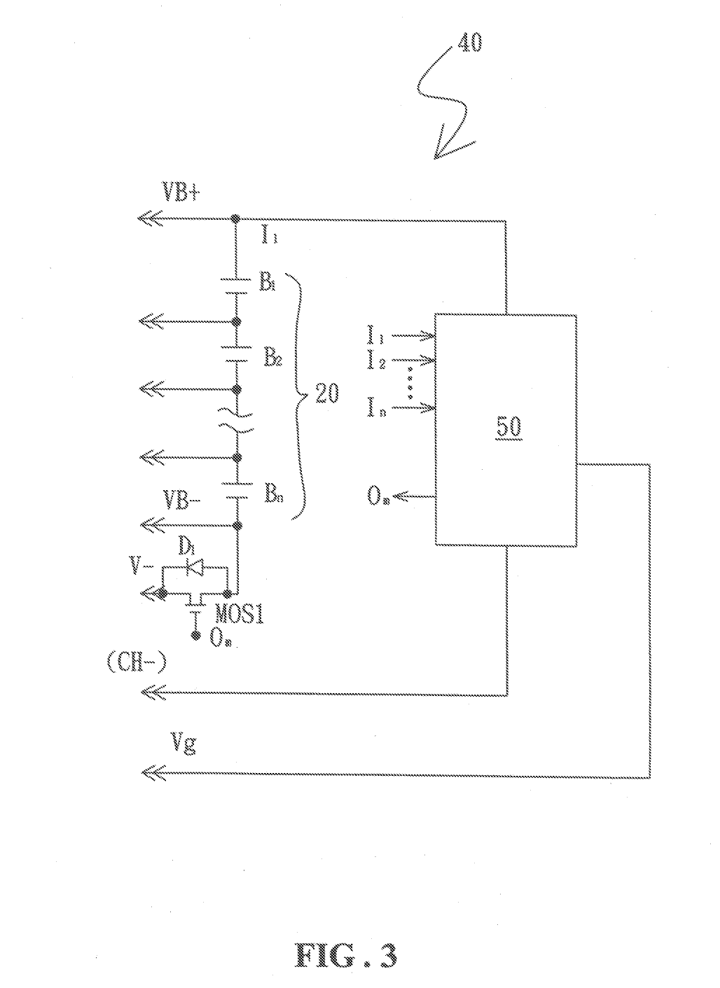

FIG. 3 shows a further example, which is structured in the architecture of FIG. 2 and further comprises a protection circuit 50, a transistor switch MOS1, and a first diode D1 arranged in the battery pack 40, which together with one or more thermal resistor Rth mentioned previously, serves as a protection element that protects the lithium batteries B1, B2, Bn against under-voltage or over-temperature when the lithium batteries are electrically loaded (such as turning on a power tool) and discharge. The protection circuit 50 has a power supply terminal connected to VB+, and a grounding terminal connected to the negative electrode CH− of the battery discharging circuit, and normally consumes no power so that only when load is initiated and CB− and VB− are coupled to each other by the operation of a switch that is provided on the power tool, can power be consumed by the circuit to effect the protection. A signal Vg is supplied by the load switching operation to conduct on MOS1 for controlling the load (namely, a trigger terminal of the transistor is conducted on by a load switch-on signal Vg of the switching operation of the load, and normally, the grounding terminal of the circuit 50 is connected to VB−, which is the negative electrode VB− of the discharging circuit of the battery set 20 so that no power is consumed normally, and only when load is initiated, power is consumed to ensure the protection mechanism).

The transistor switch MOS1 is arranged in the discharging circuit of the battery set 2, and has a first terminal connected to the negative electrode VB− of the discharge circuit of the battery set 20 and a second terminal supplying a signal V−, and a control terminal is driven by a control signal Om from the protection circuit 50. The first diode D1 is connected between the first and second terminals of the transistor switch MOS1 so that when electrical current is discharged to the load, the protection circuit 50 detects the voltage I1, I2, In of each lithium battery and the voltage of the previously mentioned thermal resistor Rth. During the discharging process, when the voltage I1, I2, In of airy lithium batteries B1, B2, Bn gets lower than a preset threshold, or when abnormal temperature occurs, the protection circuit 50 generates the control signal Om to instruct the transistor switch MOS1 to cut off the discharging circuit.

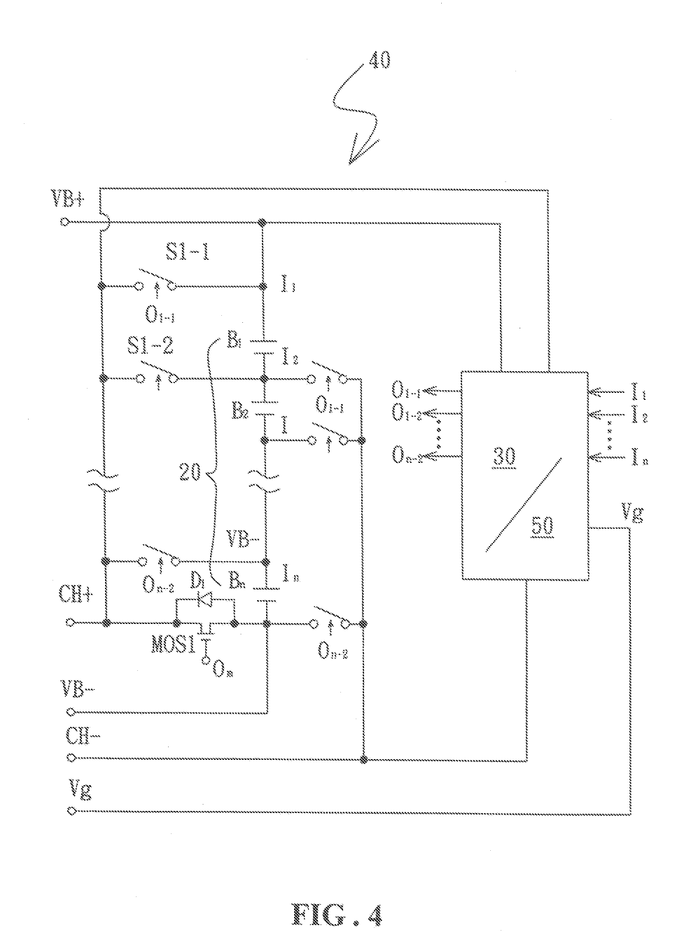

In accordance with another example of the balanced charging/discharging circuit of lithium battery pack of the present invention, the battery pack can be structured as shown in FIG. 4, wherein a battery set 20 formed by serially connecting a plurality of lithium batteries B1, B2, Bn, the control circuit 30, and the protection circuit 50 and the transistor switch MOS1 mentioned previously are together packaged in the same battery pack 40 and the protection circuit 50 is included in the control circuit 30 so that the control circuit 30 provides an external terminal for receiving the load switch-on signal Vg for conduction on, and the transmission line for transmission of the load switch-on signal Vg can be a single line that achieves bi-directional communication with the discharging circuit through standard communication protocol, and grounding of the circuit is arranged in the battery charging circuit and positive power is connected in parallel to the positive electrode CH+ of the battery charging circuit and the positive electrode VB+ of the discharging circuit for power supply, and when the power tool is turned on, the negative electrode CH− of the battery charging circuit and the negative electrode VB− of the discharging circuit are shorted by the switch of the power tool, so that in the charging process, each lithium battery B1, B2, Bn can be charged to a proper and precise voltage level, while in the discharging process, the voltage of each lithium battery B1, B2, Bn can be kept not lower than a preset value and protection is effected against discharging in abnormal temperature and thus even though there is minor leakage current, the lithium battery B1, B2, Bn can maintain sufficient power after a long term on-shelf period, and can be integrated as a conventional battery pack 40 for replacing the currently existing products.

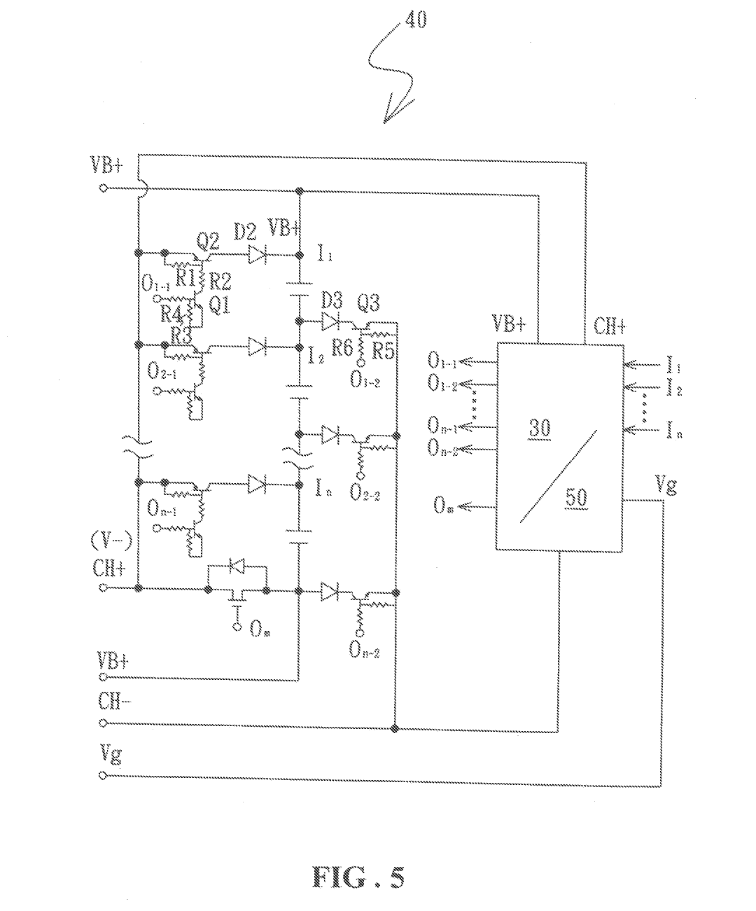

In a former example of battery pack shown in FIG. 5, means controlled by the control signals O1−1, O2−1, On−1 to establish connection with the positive electrode CH+ of the battery chatting circuit is that the positive electrodes of the lithium batteries B1, B2, Bn are each subject to switching induced by a switching circuit that is composed, of a first transistor Q1, a second transistor Q2, a first resistor R1, a second resistor R2, a third, resistor R3, a fourth resistor R4, and a second diode D2 and controlled by the control circuit 30. In embodiment illustrated, the first transistor Q1 is an NPN transistor, while the second transistor Q2 is an NPN bipolar transistor or a P-channel MOSFET, wherein an emitter of the second transistor Q2 is connected to an end of fee first resistor R1 and the positive electrode CH+ of the battery charging circuit; a collector of the second transistor Q2 is connected, through the second diode D2, to the positive electrode of the corresponding lithium battery B1 or B2 or Bn; another end of the first resistor R1 that is not connected to the emitter of the second transistor Q2 is connected to a base of the second transistor Q2 and is also connected in series with the second resistor R2, which is then connected to a collector of the first transistor Q1; an emitter of the first transistor Q1 is connected through the third resistor R3 to a base of the first transistor Q1; and the base of the first transistor Q1 is connected through the fourth resistor R4 to a terminal of the control circuit 30 that supplies a corresponding control signal O1−1 or O2−1 or On−1 so that the first transistor Q1, when conducted on by the corresponding control signal O1−1 or O2−1 or On−1 supplied from the control circuit 30, conducts on the second transistor Q2, and when the first transistor Q1 is conducted off, the second transistor Q2 goes off and is protected from reversal voltage by the second diode D2.

Means controlled by the control signals O1−2, O2−2, On−2 to establish connection with the negative electrode CH− of the battery charging circuit is that the negative electrodes of the lithium batteries B1, B2, Bn are each subject to switching induced by a switching circuit that is composed of a third transistor Q3, a fifth resistor R5, a sixth resistor R6, and a third diode D3 and controlled by the control circuit 30. In embodiment illustrated, the third transistor Q3 is an NPN bipolar transistor or an N-channel MOSFET, wherein a collector of the third transistor Q3 is connected through the third diode D3 to the negative electrode of the corresponding lithium battery B1 or B2 or Bn; an emitter of the third transistor Q3 is connected through the fifth resistor R5 to a base of the third transistor Q3; and the base of the third transistor Q3 is connected through the sixth resistor R6 to an terminal of the control circuit 30 that supplies a corresponding control signal O1−2 or O2−2 or On−2 so that the third transistor Q3 is conducted on when receiving the corresponding control signal O1−2 or O2−2 or On−2 supplied from the control circuit 30, and is protected from reversal voltage by the third diode D3 and normally, when the lithium batteries are in stock alone, or are individually disposed in a power tool with the switch of the tool not actuated, VB− and CH− are open-circuited and thus the control circuit 30 is separated from the power source. The transistor switch MOS1 of the discharging circuit is off, making the leakage current small. When the battery set 20 is fit into the power tool, actuation of the switch of the power tool makes the negative electrode VB− of the discharging circuit and the negative electrode CH− of the battery charging circuit connected to each other, and the control circuit 30 being in a controlled discharging condition, supplying the switch-on signal Vg to communicate with the tool switch for carrying out detection of battery voltage and temperature for each lithium battery, and automatically open-circuiting the discharging circuit when abnormality occurs to effect protection. In a charging condition, the grounding terminal of the control circuit 30 is connected to the negative electrode CH− of the battery charging circuit, and the power terminal carries out power supply through the positive electrode CH+ of the battery charging circuit and using the terminal that issues the switch-on signal Vg to determine the charging condition and maintain constant communication with battery charging circuit.

It is apparent from the above description that the balanced charging/discharging circuit for lithium battery in accordance with the present invention can effect protection of the battery set by cutting off charging/discharging current when overeating occurs in the charging/discharging process and allow each individual lithium battery to be optimally charged in the charging process, and prevents each lithium battery from exceeding a preset lower limit during the discharging process. Battery packs that are arranged in series or in parallel can be charged with the maximum charging current, and the service life is extended and charging time is shortened.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1: A balanced charging/discharging circuit for a lithium battery set, comprising a plurality of serially connected lithium batteries each having a positive electrode controlled by a corresponding control signal to selectively establish connection with a positive electrode of a battery charging circuit, and a negative electrode controlled by a corresponding control signal to selectively establish connection with a negative electrode of the battery charging circuit, voltage of the positive and negative electrodes of each of the serially connected lithium batteries being transmitted to a corresponding terminal of a control circuit respectively so that the control circuit generates a corresponding transfer signal to the battery charging circuit and supplies the control signal to establish connection of a corresponding series of lithium batteries for charging, the control circuit comprising a single-chip microprocessor that constantly detects the voltage of each lithium battery and operates with built-in program to determine to charge which series of lithium battery or to charge which individual lithium battery by driving only one control signal to establish connection with the positive electrode of the battery charging circuit and driving only one control signal to establish connection with the negative electrode of the battery charging circuit without other connection established by other control signals so as to charge the corresponding series of successive lithium batteries or a corresponding individual lithium battery, the control circuit being arranged close to the lithium batteries and comprising at least one protection element, which cuts off charging/discharging current for protecting the battery set when over-heating occurs in charging or discharging, so that each individual lithium battery achieves an optimum charging condition in a charging process and each individual lithium is prevented from exceeding a preset low voltage limit in a discharging process.

2: The balanced charging/discharging circuit as claimed in claim 1, wherein at least one protection element is arranged next to the lithium batteries and inside the control circuit close to the lithium batteries, comprising one or more thermal resistors to serve as the protection element, detection of variation of resistance of the thermal resistor indicating variation of temperature of the lithium batteries, based on which protection against abnormal temperature is effected.

3: The balanced charging/discharging circuit as claimed in claim 1, wherein means for employing the control signal to establish connection with the positive electrode of the battery charging circuit comprises a signal-steering switch.

4: The balanced charging/discharging circuit as claimed in claim 3, wherein the signal-steering switch and the control circuit are included in the battery charging circuit.

5: The balanced charging/discharging circuit as claimed in claim 4, wherein the battery set that is formed by serially connecting a plurality of individual lithium batteries is connected with one or more thermal resistor with the thermal resistor serving as a protection element, and being packaged together in a battery pack with the positive and negative electrodes of each lithium and an un-connected end of the thermal resistor exposed outside the battery pack to form mating terminals, to which counterpart terminals formed in the battery charging circuit correspond, so that to carry out charging operation, the mating terminals engage the counterpart terminals to complete a charging mechanism.

6: The balanced charging/discharging circuit as claimed in claim 4, wherein the battery pack comprises a protection circuit, a transistor switch and a first diode and is connected to one or more thermal resistor, serving as a protection element that protects the lithium batteries against under-voltage or over-temperature when the lithium batteries are electrically loaded and discharge, the protection circuit having a power supply terminal connected to the positive electrode of the battery discharging circuit, and a grounding terminal connected to the negative electrode of the battery discharging circuit, so as to normally consume no power and only when load is initiated and the positive electrodes of the battery charging circuit and the discharging circuit are coupled to each other by operation of a switch that is provided on a power tool, can power be consumed by the circuit to effect the protection, a switch-on signal being supplied by the load switching operation to conduct on the transistor switch for controlling the load, namely, a trigger terminal of the transistor being conducted on by a load switch-on signal of the switching operation of the load, and normally, the grounding terminal of the circuit being connected to the negative electrode of the battery discharging circuit so that power is consumed to effect protection mechanism only when the load is initiated, the transistor switch being arranged in the discharging circuit, and having a first terminal connected to the negative electrode of the discharge circuit and a second terminal supplying a signal, and a control terminal of the transistor switch being driven by a control signal from the protection circuit, the first diode being connected between the first and second terminals of the transistor switch so that when electrical current is discharged to the load, the protection circuit detects the voltage of each lithium battery and a voltage of the thermal resistor, and during the discharging process, when the voltage of one of the lithium batteries gets lower than a preset threshold, or when abnormal temperature occurs, the protection circuit generating a control signal to instruct the transistor switch to cut off the discharging circuit.

7: The balanced charging/discharging circuit as claimed in claim 6, wherein the battery set formed by serially connecting a plurality of lithium batteries, the control circuit, and the protection circuit and the transistor switch are together packaged in the same battery pack, and the protection circuit is included in the control circuit so that the control circuit provides an external terminal for receiving the load switch-on signal for conduction on, and grounding of the control circuit being arranged in the discharging circuit and positive power being connected in parallel to the positive electrode of the battery charging circuit and the positive electrode of the discharging circuit for power supply, and the negative electrodes of the battery charging circuit and the discharging circuit being shorted by the switch of the load.

8: The balanced charging/discharging circuit as claimed in claim 7, wherein a transmission line for transmission of the load switch-on signal comprises a single line that achieves bi-directional communication through standard communication protocol.

9: The balanced charging/discharging circuit as claimed in claim 1, wherein means controlled by the control signals for establishing connection with the positive electrode of the battery charging circuit comprises that the positive electrodes of the lithium batteries are each subject to switching induced by a switching circuit that is composed of a first transistor, a second transistor, a first resistor, a second resistor, a third resistor, a fourth resistor, and a second diode and controlled by the control circuit, and wherein an emitter of the second transistor is connected to an end of the first resistor and the positive electrode of the battery charging circuit; a collector of the second transistor is connected, through the second diode, to the positive electrode of the corresponding lithium battery; another end of the first resistor that is not connected to the emitter of the second transistor is connected to a base of the second transistor and is also connected in series with the second resistor, which is then connected to a collector of the first transistor; an emitter of the first transistor is connected through the third resistor to a base of the first transistor; and the base of the first transistor is connected through the fourth resistor to a terminal of the control circuit that supplies a corresponding control signal so that the first transistor when conducted on by the corresponding control signal supplied from the control circuit, conducts on the second transistor, and when the first transistor is conducted off, the second transistor goes off and is protected from reversal voltage by the second diode.

10: The balanced charging/discharging circuit as claimed in claim 1, wherein means controlled by the control signals for establishing connection with the negative electrode of the battery charging circuit comprises that the negative electrodes of the lithium batteries are each subject to switching induced by a switching circuit that is composed of a third transistor, a fifth resistor, a sixth resistor, and a third diode and controlled by the control circuit, and wherein an emitter of the third transistor is connected through the third diode to the negative electrode of the corresponding lithium battery; a collector of the third transistor is connected through the fifth resistor to a base of the third transistor; and the base of the third transistor is connected to an terminal of the control circuit that supplies a corresponding control signal so that the third transistor is conducted on when receiving the corresponding control signal supplied from the control circuit, and is protected from reversal voltage by the third diode.

11: The balanced charging/discharging circuit as claimed in claim 9, wherein the first transistor comprises an NPN transistor and the second transistor comprises an NPN bipolar transistor.

12: The balanced charging/discharging circuit as claimed in claim 9, wherein the first transistor comprises an NPN transistor and the second transistor comprises a P-channel MOSFET.

13: The balanced charging/discharging circuit as claimed in claim 10, wherein the third transistor comprises an NPN bipolar transistor.

14: The balanced charging/discharging circuit as claimed in claim 10, wherein the third transistor comprises an N-channel MOSFET.

15: The balanced charging/discharging circuit as claimed in claim 1, wherein the battery charging circuit comprises a power source, which is a switching power supply.

16: The balanced charging/discharging circuit as claimed in claim 1, wherein the battery charging circuit comprises a power source, which comprises a transformer.
